(19) United States
(12) Patent Application Publication
(10) Pub. No.: US 2015/0330745 A1
(43) Pub. Date: Nov. 19, 2015

(54) PROTECTIVE DEVICE

(71) Applicant: B-MAX S.R.L., Empoli (IT)

(72) Inventor: Cosimo CIOFFI, Cerreto Guidi (IT)

(21) Appl. No.: 14/652,663

(22) PCT Filed: Dec. 18, 2012
(86) PCT No.: PCT/IT2012/000385

§ 371 Date: Jun. 16, 2015

(51) Int. Cl. F41H 5/04; B32B 15/088; B32B 3/30; B32B 15/085; B32B 7/08; B32B 3/26; B32B 15/08; B32B 15/095

(52) U.S. Cl. CPC F41H 5/0457; B32B 15/08; B32B 15/088; B32B 15/095; B32B 15/085; B32B 7/08; B32B 3/266; B32B 3/30; B32B 2255/10; B32B 2571/00

(57) ABSTRACT

Described is a protecting device comprising a first internal resistant layer (2) made from a steel having a failure load equal to or greater than 30,000 kg/cm² and perfectly elastic between 0 and at least 10,000 kg/cm', and at least one second layer (3) made from polymeric material.

### TECHNICAL FIELD

This invention relates to a protective device, in particular for objects or structures against shock waves, to protect persons or objects inside.

### BACKGROUND ART

Protective devices are known, for example in patent application nos. WO2007/042877 and WO2010/049802 in the name of the same Applicant and having the same inventor as this invention.

These structures have a core made of resistant material and an outer coating which can be perforated made of polymeric material. The resistant core is made from a material which is able to resist a perforating body, and, for that purpose, it can be made, for example, from a steel pate stiffened with circling crosspieces.

The polymeric coating layer is, on the other hand, designed to break when penetrated by the perforating body so as to constitute an obstacle to the rebounding of the perforating body after the impact against the resistant core.

These prior art devices, although they operate in an optimum manner from the point of view of resistance to perforating bodies, are not specifically designed to resist impacts such as, in particular, those generated by shock waves from explosions.

The necessary resistance to the perforating bodies (the action of which is concentrated in a small localised area) requires that the materials used for the resistant core has a high degree of hardness, even at the expense of the overall fragility of the resistant core. Amongst the materials used there are, for example, certain hardened glasses or fibre cement.

The above-mentioned fragility makes this type of structure unsuitable for resistance against impacts, such as shock waves caused by explosions, since the hardness provided by the materials used does not have a protective effect against the impact and the structure, therefore, is not sufficiently effective for this type of use.

### DISCLOSURE OF THE INVENTION

The aim of this invention is therefore to provide a protective device which is effective against the effects of shock waves (the so-called “blast wave” effect).

This invention also relates to a method for making the protection device.

### BRIEF DESCRIPTION OF THE DRAWINGS

Further features and advantages of the invention are more apparent in the non-limiting description which follows of a preferred non-limiting embodiment of the invention illustrated in the accompanying drawings, in which:

FIG. 1 shows a schematic transversal cross section of a protection device according to this invention;

FIG. 2 shows a second application of a device of FIG. 1.

FIG. 3 shows a third application of a device according to this invention and

FIG. 4 shows a fourth application of a device according to this invention.

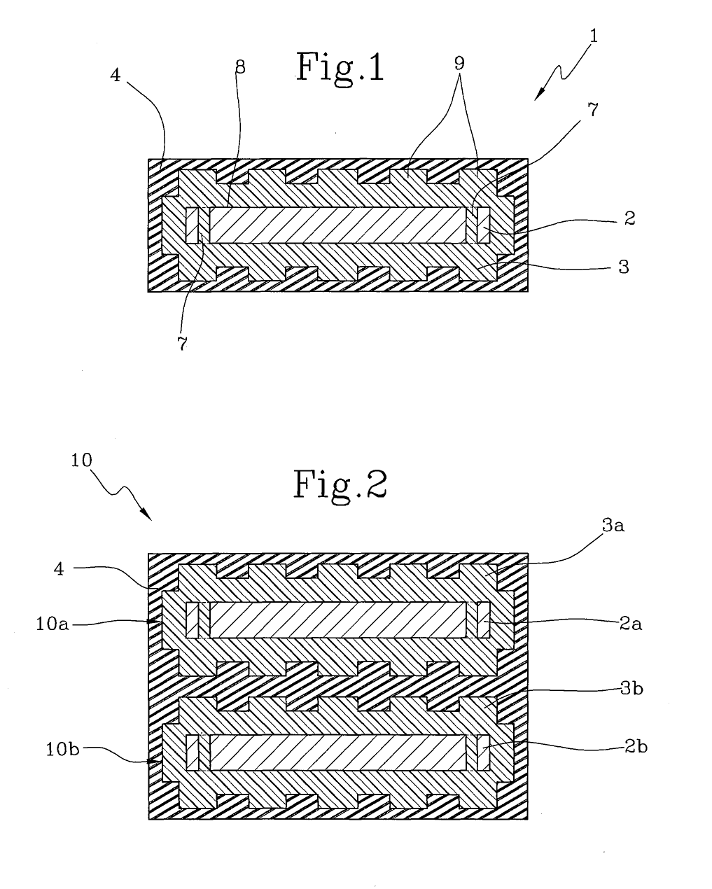

### DETAILED DESCRIPTION OF THE PREFERRED EMBODIMENTS OF THE INVENTION

The accompanying drawings show a protective device according to this invention comprising a protective structure 1.

The structure 1 comprises a first, internal, resistant layer 2, forming the resistant layer of the structure 1.

The internal layer 2 is made of an elastic steel, that is to say, a steel having a metallurgical structure and heat treatments for improving the elastic characteristics.

Preferably, the steel has a failure load equal to or greater than approximately 30,000 kg/cm² and it is perfectly elastic (that is to say, with complete elastic return without yield or permanent deformations) between 0 and at least 20,000 kg/cm².

The above-mentioned resistance values are considered to be obtained by a plate having a thickness of 6-8 mm.

In a preferred embodiment, the steel used for the inner layer 2 is a hardened and tempered, non-ballistic steel (the term “non-ballistic” means a particularly hard and very fragile steel due to the high content of manganese.

Preferably, the steel used has a hardness lower than that of ballistic steel.

More specifically, the steel used has a hardness of less than 72 HRC.

The first layer 2 has a thickness of between 1 and 10 millimetres, preferably 7 millimetres.

The structure 1 also comprises a second layer 3 positioned in contact with the first layer 2 and made from a polymeric material (containing polymers, co-polymers or a blend).

Preferably, the polymeric material used for the second layer 3 is a material selected amongst polyamide, polyurethane, polypropylene, polyvinyl chloride (PVC) and derivatives of these materials (that is, a composition of predetermined percentages of two or more of the above-mentioned materials).

Preferably, the second layer 3 has a thickness of between 6 and 9 millimetres.

The second layer

Advantageously, the first layer comprises a series of passages 7 designed to receive the second layer 3 for obtaining a coupling of the layers 2 and 3 which are not mutually slidable.

In effect, the layer 3 is fixed to the layer 2 not only due to the contact on the lateral surfaces 8 but also inside the passages 7.

Preferably, the structure 1 also comprises a coating layer 4 positioned to cover the first and the second layer 2, 3.

The coating layer 4 is made from a polymeric material, preferably comprising rubber or nylon and yet more preferably having nylon-based polyamides, polyethylenes or polyurethanes and containing a percentage of rubber of between 20% and 40%.

Preferably, the coating layer 4 has a thickness of between 4 and 20 millimetres.

Advantageously, the second layer 3 comprises protrusions 9 on the relative outer surface so as to obtain a complete coupling with the coating layer 4.

Thanks to the use of the above-mentioned materials, the layers 2, 3, 4 are slidably coupled to each other and therefore provide a considerable collaboration in the bending strength. This configuration allows a deflection which is greater than that of a structure with the same layers but positioned in such a way that the tangential sliding is free.

In other words, the materials constituting the various layers 2, 3, 4 link together, thereby increasing the mutual coupling.

Advantageously, the second layer 3 and the coating layer 4 are positioned on the layer 2 by thermal die-casting.

In this way an increase in the impact strength and the absorption of the total kinetic energy of the entire protective device is obtained whilst at the same time maintaining a high elasticity.

This results in a greater energy absorption capacity, which is particularly useful in the absorption of shock waves, for example due to earthquakes, explosions or fires.

In addition, the presence of the second layer 3 provides an anti-rebound effect which is able to retain any fragments transported by the shock wave, thereby preventing them from rebounding on the second resistant layer 2 and being reintroduced into the surrounding environment.

According to this invention, the above-mentioned protective device 1 can be applied to various types of clothing, such as vests or in general to other types of self-protection clothing, to vehicles, boats, aircraft or fixed structures such as, for example, engine or turbine testing buildings or cabins, so as to prevent the released parts, in the event of failure of the engine or the turbine, from darting without control into the environment and rebounding on the walls, reaching other objects or operators present.

In a preferred embodiment, a method for making the protective device comprises a first step of applying, by moulding (thermal die-casting), the second layer 3 to the first layer 2 to obtain a semi-finished product co-moulded in two layers, and a subsequent step of moulding (thermal die-casting) the coating layer 4 on the above-mentioned semi-finished product.

FIG. 2 schematically shows a second embodiment of a protective device comprising a structure 1 comprising a first 2a and a second 2b resistant layer on which are individually positioned, advantageously by thermal die-casting, a respective first 3a and second 3b polymeric layer so as to obtain two modules 10a, 10b.

Then, the two above-mentioned semi-finished products 10a and 10b are completely wrapped by a shared coating layer 4 so as to obtain a single module 10.

It is understood that the number of resistant layers 2 and polymeric layers 3 can also be greater than two depending on the specific conditions to which the object (clothing, vehicle, building . . . ) designed to be protected by the structure 1 according to this invention must resist.

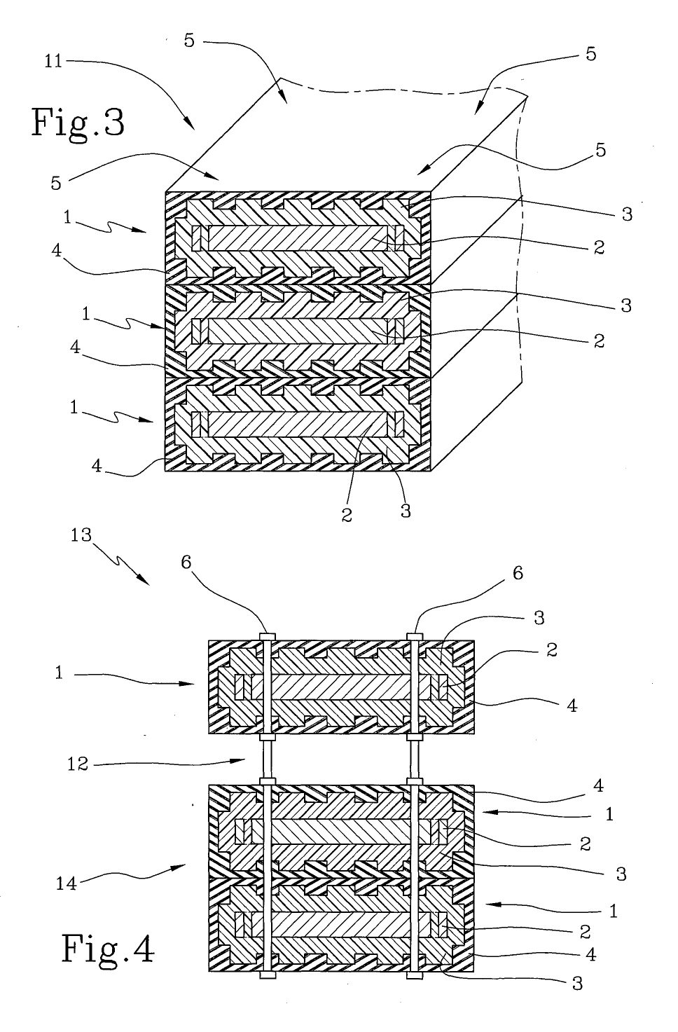

FIG. 3 schematically shows a third embodiment of a protective device 1 comprising a plurality of structures 1 coupled by means of through fixing elements 5 to obtain a coupling 11, for example rigid connecting bars passing through the structures 1.

This solution enables the resistance values of the coupling 11 to be modulated depending on the specific conditions to which the object (clothing, vehicle, building . . . ) designed to be protected by the device according to this invention must resist.

FIG. 4 schematically shows a further embodiment of a protective device comprising a first structure 1 connected to a module 10 (as described with reference to FIG. 2) or to a coupling 11 (as described with reference to FIG. 3) or to a single structure 1, by means of connecting means 6, for example threaded rigid bars.

Between the structure 1 and the module 10 (or the coupling 11) the solution comprises at least one gap 12, advantageously of 2-30 cm.

The gap is advantageously filled with a gas, preferably air.

As well as modulating the resistance values of the entire device, increasing or decreasing the resistant layers 1 of which it is composed, this solution also allows another advantage to be obtained in terms of dispersion of the shock wave due to explosions or fires.

More specifically, the presence of the gap 12 allows the shock wave to be provided with a lateral escape path, without, therefore, further stressing the rear part 14 of the protective device.

It is understood that the solution of FIG. 4 can comprise a series of structures 1 and a series of modules 10 (or couplings 11) all interposed with respective gaps 12.

This invention achieves the set aim.

The advantages achieved in terms of resistance to shock waves, in particular due to earthquakes, explosions or fires, consist in the fact that a protective device as described guarantees a sufficient deformability guaranteed mainly by the mechanical properties of the resistant layer made of steel, such as to maintain the structural integrity, that is to say, the resistance to the disgregation resulting from the blast.

At the same time, the effect of the presence of the second layer made of polymeric material allows stray fragments to be stopped, preventing the rebound on the resistant layer and thus preventing a dangerous reintroduction into the surrounding environment.

1. A protective device comprising at least one protective structure (1), the structure comprising a first internal resistant layer (2) made from a steel having a failure load equal to or greater than 30,000 kg/cm² and perfectly elastic between 0 and at least 10,000 kg/cm², and at least one second layer (3) made from polymeric material positioned in contact with the first layer (2).

2. The protective device according to claim 1 comprising a plurality of the structures (1) and also comprising connecting means (5, 6) for keeping the structures (1) joined together.

3. The protective device according to claim 2 characterised in that at least two of the structures (1) are spaced from each other by a gap (12) having a thickness of between 2 and 30 cm.

4. The protective device according to claim 3 wherein the gap is filled with a gas, preferably air.

5. The protective device according to claim 1 wherein the connecting means (5, 6) comprise a plurality of connecting bars (5, 6) passing through the protective structures (1).

6. The device according to claim 1 wherein the structure comprises at least one second layer (3) made from a polymeric material selected amongst polyamide, polyurethane, polypropylene, PVC and derivatives of these materials.

7. The device according to claim 1, also comprising a third coating layer (4) made from a nylon-based polymeric material containing a percentage of rubber of between 20% and 40%.

8. The device according to claim 1 wherein the first resistant layer (2) comprises a plurality of passages (7) for the second layer (3).

9. The device according to claim 1 wherein the second layer (3) comprises a plurality of protrusions (9) for increasing the coupling force between the second layer (3) and the coating layer (4).

10. The device according to claim 1 wherein the first layer (2) has a thickness of between 1 and 10 millimetres and wherein the second layer (3) has a thickness of between 6 and 9 millimetres.

11. The device according to claim 4 wherein the third coating layer (4) has a thickness of between 4 and 20 millimetres.

12. The device according to claim 1 comprising at least two resistant layers (2a, 2b) coupled to at least two respective polymeric layers (3a, 3b) and held together by a single shared coating layer (4).

13. A process for making a protective device, comprising a step of preparing a first resistant layer (2) made from a steel having a failure load equal to or greater than 30,000 kg/cm² and perfectly elastic between 0 and at least 10,000 kg/cm², and a subsequent step of moulding, on the first layer (2), at least one second layer (3) made from polymeric material, obtaining a structure with two layers.

14. The process according to claim 13, also comprising a subsequent step of moulding, on the two-layer structure, a coating layer (4) made from a nylon-based polymeric material containing a percentage of rubber of between 20% and 40%.

15. The process according to claim 13 wherein the moulding steps comprise a thermal die-casting step.
